(19) United States
(12) Patent Application Publication
(10) Pub. No.: US 2026/0323132 A1
(43) Pub. Date: Oct. 15, 2026

(54) METHOD AND APPARATUS FOR AUTOMATED POSITIONING OF CLOSED CAPTIONS

(71) Applicant: DISH Network L.L.C., Englewood, CO (US)

(72) Inventor: Aravind Soundararajan, Englewood, CO (US)

(21) Appl. No.: 19/178,507

(22) Filed: Apr. 14, 2025

(51) Int. Cl. H04N 21/488; H04N 21/44

(52) U.S. Cl. CPC H04N 21/4884; H04N 21/44008

(57) ABSTRACT

A method for positioning captions may include determining a first unoccupied display area of a first video frame. The method may include determining a first position of a first caption in the first unoccupied display area. The method may include inserting first caption data into the first video frame, the first caption data corresponding to the first caption in the first unoccupied display area. The method may include determining a second unoccupied display area of a second video frame. The method may include determining a second position of a second caption in the second unoccupied display area. The method may include inserting second caption data into the second video frame, the second caption data corresponding to the second caption in the second unoccupied display area. The method may include transmitting the first video frame and the second video frame to a display device.

### BACKGROUND

Closed captions enhance video content accessibility for diverse users, including those with hearing impairments, language barriers, or a personal preference for closed captioning. However, traditional fixed positioning often obstructs critical on-screen information, diminishing the viewing experience. While standards like EIA-708 allow for dynamic caption placement, current solutions rely on predictable screen layouts and fail to perform real-time, frame-by-frame adjustments, limiting their effectiveness in addressing overlapping visual elements.

### BRIEF SUMMARY

A system may include a machine learning module, one or more processors and a non-transitory computer readable medium including instructions that, when executed by the one or more processors, cause the system to perform operations. According to the instructions, the system may determine, by the machine learning module, a first unoccupied display area of a first video frame. The system may determine, by the machine learning module, a first position of a first caption in the first unoccupied display area. The system may insert first caption data into the first video frame, the first caption data corresponding to the first caption in the first unoccupied display area of the first video frame. The system may determine, by the machine learning module, a second unoccupied display area of a second video frame. The system may determine, by the machine learning module, a second position of a second caption in the second unoccupied display area. The system may insert second caption data into the second video frame, the second caption data corresponding to the second caption in the second unoccupied display area of the second video frame. The system may transmit the first video frame and the second video frame to a display device to be rendered for display.

In some embodiments, the first unoccupied display area may be determined at least partially by detecting an absence of important text in at least a portion of the first video frame and the second unoccupied display area may be determined at least partially by detecting an absence of important text in at least a portion of the second video frame. The first caption and the second caption may be inserted in a first position based on coordinates defined by the first video frame and the second video frame. The first caption may be inserted in a first position based on coordinates defined by the first video frame and the second caption is inserted in a second position based on coordinates defined by the second video frame. A difference between the first position and the second position may be below a predetermined threshold. The predetermined threshold may be based at least partially on time and the first position of the first caption. The first video frame may be associated with a first display time and the second video frame may be associated with a second display time, where a time difference between the first display time and the second display time is between about 16 milliseconds to about 42 milliseconds. A difference between the first position and the second position may be less than or equal to 10%. The machine learning module may be implemented by an edge device. The machine learning module may be implemented on a remote computing device.

A method for positioning closed captions may include determining, by a machine learning module implemented on a computing system, a first unoccupied display area of a first video frame. The method may include determining, by the machine learning module, a first position of a first caption in the first unoccupied display area. The method may include inserting, by the computing system, first caption data into the first video frame, the first caption data corresponding to the first caption in the first unoccupied display area of the first video frame. The method may include determining, by the machine learning module, a second unoccupied display area of a second video frame. The method may include determining, by the machine learning module, a second position of a second caption in the second unoccupied display area. The method may include inserting, by the computing system, second caption data into the second video frame, the second caption data corresponding to the second caption in the second unoccupied display area of the second video frame. The method may include transmitting, by the computing system, the first video frame and the second video frame to a display device to be rendered for display.

In some embodiments, the method may include: the first unoccupied display area is determined at least partially by detecting an absence of important text in at least a portion of the first video frame; and the second unoccupied display area is determined at least partially by detecting an absence of important text in at least a portion of the first video frame. The first caption and the second caption may be inserted in a first position based on coordinates defined by the first video frame and the second video frame. The first caption may be inserted in a first position based on coordinates defined by the first video frame and the second caption may be inserted in a second position based on coordinates defined by the second video frame. A difference between the first position and the second position may be below a predetermined threshold. The predetermined threshold may be based at least partially on time and the first position of the first caption. Determining the first unoccupied display area of the first video frame may include determining a first occupied display area of the first video frame, where the first occupied display area is defined by a bounded area of the first video frame designated for displaying text, and at least a portion of a remaining area of the first video frame defines the first unoccupied display area. Determining the second unoccupied display area of the second video frame may include determining a second occupied display area of the second video frame, where the second occupied display area is defined by a bounded area of the second video frame designated for displaying text, and at least a portion of a remaining area of the second video frame defines the second unoccupied display area. The machine learning module may include at least one of an optical character recognition engine, a deep learning-based text detection model, a convolutional neural network-based object detection model, a transformer-based detection model, a computer vision library, a cloud-based vision analysis service, or a custom-trained machine learning framework. The computing system may include at least one of a set top box or a television.

A non-transitory computer-readable medium may comprise instructions that, when executed by one or more processors, cause the one or more processors to perform operations. The operations may include determining, by a machine learning module implemented on a computing system, a first unoccupied display area of a first video frame. The operations may include determining, by the machine learning module, a first position of a first caption in the first unoccupied display area. The operations may include inserting, by the computing system, first caption data into the first video frame, the first caption data corresponding to the first caption in the first unoccupied display area of the first video frame. The operations may include determining, by the machine learning module, a second unoccupied display area of a second video frame. The operations may include determining, by the machine learning module, a second position of a second caption in the second unoccupied display area. The operations may include inserting, by the computing system, second caption data into the second video frame, the second caption data corresponding to the second caption in the second unoccupied display area of the second video frame. The operations may include transmitting, by the computing system, the first video frame and the second video frame to a display device to be rendered for display.

### BRIEF DESCRIPTION OF THE DRAWINGS

FIG. 1 is an example system and process which may be used for positioning closed captions, according to certain embodiments.

FIG. 2A depicts an example video frame being processed for positioning closed captions, according to certain embodiments.

FIG. 2B depicts an example system for positioning closed captions, according to certain embodiments.

FIG. 2C depicts a processed video frame, according to certain embodiments.

FIG. 3 relates to a training process of a machine learning algorithm, according to certain embodiments.

FIG. 4 depicts an example computing system, according to certain embodiments.

### DETAILED DESCRIPTION

Closed captions are widely used in video display technologies, such as televisions or smart phones, to provide textual representation of audio content. Closed captions can enhance the viewing experience for a diverse range of users, such as those with hearing impairments, individuals in noisy or quiet environments, viewers seeking to comprehend audio in languages other than their own, or users who may simply prefer closed captions for enhanced comprehension or convenience. The importance of closed captions has grown significantly as video content consumption has expanded across various devices and global audiences.

The placement of closed captions on screens often poses challenges. For example, traditional solutions involve fixed caption positioning, where closed captions are disposed in a predetermined, unchanging location on the screen (typically the top center or the bottom center of the screen), irrespective of the content being shown. Consequently, captions often obstruct or overlap essential on-screen information, such as graphical text, subtitles, scoreboards, or other visual elements critical to the viewer's understanding of the content. This obstruction can lead to a diminished viewing experience, user frustration, and, in some cases, the inability to access key information.

The EIA-708 standard, defined by the Electronic Industries Alliance (EIA), addresses some of these challenges by enabling customizable and dynamic positioning of closed captions. Introduced in 1995, EIA-708 was designed as the successor to the earlier EIA-608 standard, which had been the prevailing closed captioning standard for analog television broadcasts. While EIA-608 provided basic captioning functionality, it lacked provisions for advanced features like color, font customization, and dynamic positioning. EIA-708, which was developed specifically for digital television broadcasting, introduced significant advancements including support for customizable styles, multiple languages, and more flexible caption placement. Before the release of EIA-708, captions were largely constrained to fixed positions on the screen due to technical limitations of the EIA-608 standard. This often resulted in captions overlapping critical visual elements, such as subtitles or graphics. With EIA-708, however, content creators and broadcasters gained the ability to adjust caption positioning dynamically to avoid such overlaps, improving accessibility and the overall viewing experience.

However, conventional implementations of EIA-708 have often relied on predictable screen layouts to make these adjustments. For instance, captions might be moved from the bottom center of the screen during a sports broadcast to avoid obscuring a scoreboard or subtitles. While this approach is an improvement over fixed positioning, it remains inadequate for real-time, frame-by-frame analysis and adjustment of caption placement, which is necessary to fully optimize caption visibility and minimize obstruction across diverse and unpredictable content types. Thus, even when using state-of the art techniques, the speed at which caption position must be determined may be beyond the ability of a human and/or current systems (e.g., in live television).

One solution may be a system that utilizes machine learning to determine an unoccupied display area of a video frame in real-time and determine a position of a caption in the unoccupied display area. For example, the system may analyze a video frame in real-time to determine an unoccupied display area of the video frame, determine a caption position in the unoccupied display area, access audio data associated with the video frame, insert caption data into the video frame, and transmit the video frame to a display device (e.g., a television). The unoccupied display area may be determined at least partially by detecting the absence of important text and/or other important viewing information (e.g., images, logos). This may be repeated for one or more sequential video frames, allowing the system to analyze the caption positioning in a real-time, frame-by-frame manner. This may be utilized in a variety of applications. For example, in live sports broadcasts, the system can dynamically position captions to ensure they do not obstruct critical visuals like scoreboards, player stats, or game graphics. In news broadcasts, the system can adaptively position captions to avoid overlapping with on-screen graphics, such as breaking news tickers, headlines, or visual aids like charts and maps. In streaming platforms, the system can optimize caption positioning for diverse content, such as movies, television shows, and documentaries, to ensure captions do not obstruct important visual elements, such as subtitles, cinematic text overlays, or artistic graphics. The system may be utilized with large-screen devices (e.g., televisions) or smaller-screen devices (e.g., mobile devices). By utilizing machine learning models, caption positioning may be determined at a rate not previously possible, enhancing a user experience and improving accessibility.

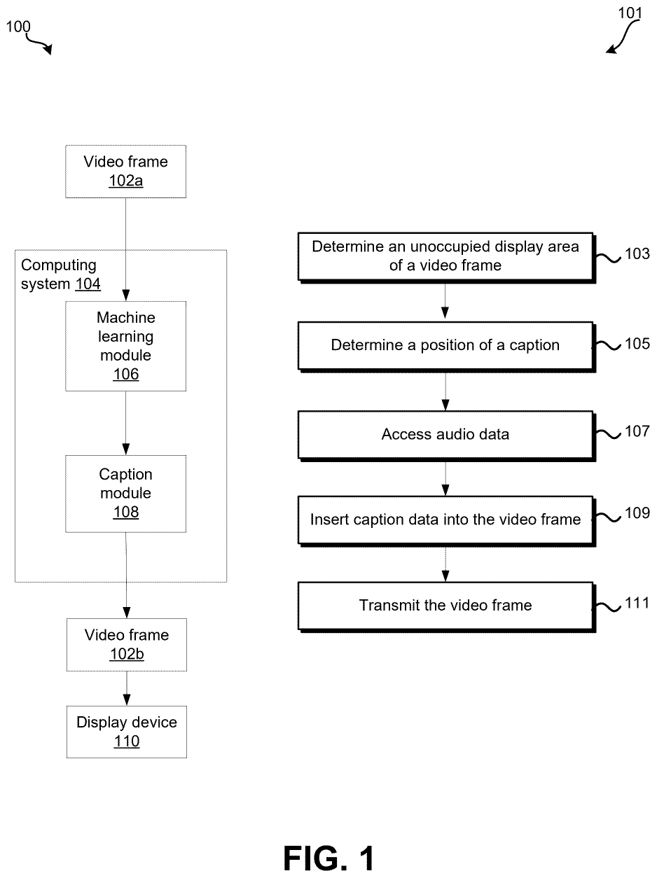

FIG. 1 illustrates an example system 100 and process 101 which may be used for positioning closed captions, according to certain embodiments. The system 100 may include video frames 102a-b, computing system 104, machine learning module (MLM) 106, caption module 108, and display device 110. However, it should be appreciated that the system 100 shown and described is just an example. The system 100 may include any element (e.g., an IoT device) in combination with or instead of any of the elements shown in FIG. 1. Furthermore, one or more of the elements shown in FIG. 1 may be reconfigured, omitted, and/or combined with other elements.

The system 100 may include one or more video frames (e.g., video frames 102a-b). As will be made apparent by the following disclosure, the system 100 may receive an input video frame (e.g., video frame 102a), analyze the video frame for caption positioning, and generate an output video frame (e.g., video frame 102b) to be transmitted to a display device to be rendered for display. The computing system 104 may receive one or more input video frames (e.g., video frame 102a) from a variety of different sources depending on the application, including but not limited to live cameras, satellite feeds, broadcast servers, or other sources. For example, the computing system 104 may receive raw video frames via a set top box or media player, which may decode the video stream into individual video frames. The video frame 102a may contain various types of data that may be analyzed for caption positioning, such as spatial information like object locations (e.g., faces, text, motion areas), color and contrast details for background readability, scene dynamics such as areas of high activity or movement, and frame metadata like resolution and aspect ratio. Additionally, preceding and/or subsequent video frames may be analyzed to provide insights into scene continuity, ensuring captions remain visually consistent and unobtrusive throughout the video.

The computing system 104 may include one or more computing devices (or other devices) working together and/or separately. For example, the computing system 104 may include a set top box and a television, connected such that the set top box can control one or more functions of the television (e.g., power on/off, volume control, caption settings, etc.). In another example, the computing system 104 may only include a television. In yet another example, the computing system 104 may include a remote control, a portable media device, such as a laptop, a tablet, and/or a smartphone, etc.

The computing system 104 may include a MLM 106. The MLM 106 may include a data input interface configured to receive text data and/or image data from one or more sources. The MLM 106 may include a pre-processing unit configured to normalize, filter, or otherwise prepare the input data for analysis. The MLM 106 may include one or more machine learning models, such as models trained to identify important visual elements (e.g., text, images, logos, objects, or other visual elements) in one or more input video frames, to determine an unoccupied display area in the one or more input video frames and a position of a caption in the respective unoccupied display areas. The MLM 106 may include an output module configured to generate an unoccupied display area and a caption position for the one or more video frames. The MLM 106 may also include a memory or storage unit for storing training data, model parameters, or configuration settings, and a processing unit configured to execute the various operations of the module. The MLM 106 may also include a feedback mechanism for refining the model based on real-time or post-analysis results and/or user feedback to improve accuracy and performance over time.

The MLM 106 may include one or more machine learning models trained to identify important text in one or more input video frames (e.g., video frame 102a). Important text may include any textual content within a video frame that conveys critical information relevant to the video's purpose or context, including but not limited to scoreboards, phone numbers, subtitles, captions, headlines, titles, timestamps, warnings, disclaimers, labels, product names, logos, and/or promotional text. However, it should be appreciated that its classification as “important” may depend on the type of video being analyzed. Models used to identify important text in video frames may include but are not limited to an optical character recognition engine, a deep learning-based text detection model, a convolutional neural network-based object detection model, a transformer-based detection model, a computer vision library, a cloud-based vision analysis service, and/or a custom-trained machine learning framework. The identification of important text may enable the MLM 106 to determine portions of the input video frame with important text and portions of the input video frame without important text, thus aiding the MLM 106 in determining an unoccupied display area of the input video frame.

The MLM 106 may include one or more machine learning models trained to identify important images. Important images may include any visual element within a video frame that conveys critical information relevant to the video's purpose or context, such as logos, faces, objects, or graphics, charts, maps, illustrations, diagrams, symbols, advertisements, and/or visual overlays like scoreboards or infographics. However, it should be appreciated that its classification as “important” may depend on the type of video being analyzed. Models used to identify important images in video frames may include but are not limited to convolutional neural networks, YOLO (You Only Look Once), SSD (Single Shot Multibox Detector), attention-based models, Vision Transformers (ViT), saliency detection models, and/or custom-trained machine learning frameworks. The identification of important images may enable the MLM 106 to determine portions of the input video frame with important images and portions of the input video frame without important images, thus aiding the MLM 106 in determining an unoccupied display area of the input video frame.

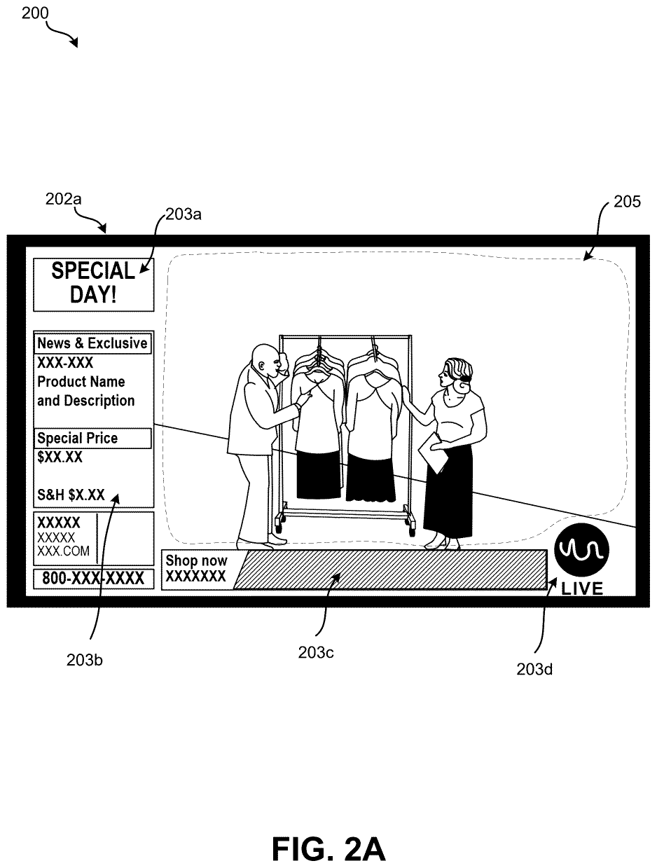

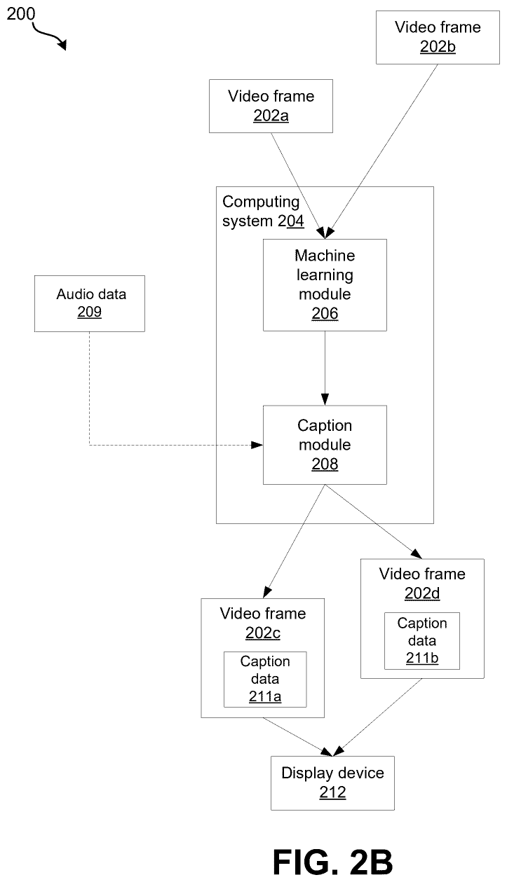

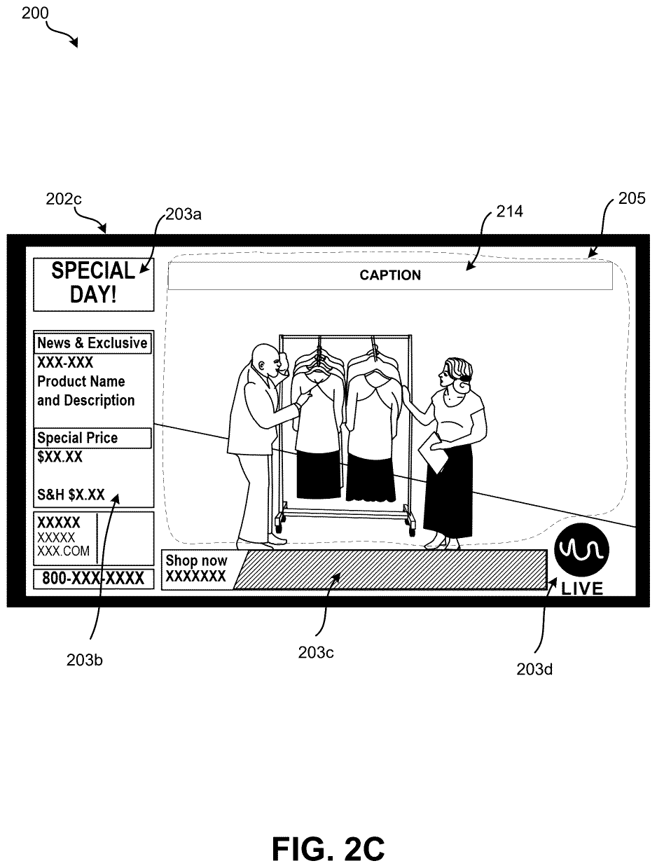

The computing system 104 may include a caption module 108. The caption module 108 may be configured to access audio data (shown in FIG. 2B) associated with one or more video frames (e.g., video frame 102a). The audio data may be included with the video frames 102a-b, and/or may be accessed in a separate data stream. The audio data may include caption text, such as from pre-exiting caption files (e.g., SRT, VTT, or SCC formats), which may be provided with a video file of the input video frame (e.g., video frame 102a). The audio data may also include waveform patterns and frequency spectrum information, which may be converted to caption text in real-time or near real-time (e.g., 1 ms, 10 ms, 50 ms, etc.). Further, the audio data may also include other data which may be provided to the MLM 106 to facilitate caption positioning, including but not limited to amplitude levels (e.g., to adjust the prominence of captions in loud or visually complex scenes), spatial audio metadata (e.g., to place captions near the location of the speaker and enhance contextual clarity), frequency spectrum data (e.g., to avoid placing captions near areas associated with distracting high-frequency sound), and other suitable data.

The computing system 104 may be configured to insert caption data into the input video frame (e.g., video frame 102a) to generate an output video frame (e.g., video frame 102b). The caption data may correspond to the caption position in the unoccupied display area and may include caption text based in part on the audio data. Thus, for example, the caption data may include metadata and instructions that determine the precise positioning and styling of captions to ensure readability while preserving the visibility of important text and images detected within occupied display areas, such as scoreboards, subtitles, logos, or faces. The caption data may specify parameters like font size, text alignment, screen coordinates, safe margins, and/or line spacing to optimize placement in unoccupied regions. Caption data may also account for dynamic motion tracking to adapt placement during scene changes, spatial audio metadata to synchronize captions with directional audio cues, temporal synchronization to match captions with audio timing, and adaptive scaling to ensure readability across varying resolutions and devices. Additionally, caption data may incorporate information from preceding and subsequent frames to maintain consistency and alignment, ensuring captions transition smoothly and do not dramatically shift placement across frames, even in dynamic or fast-changing video sequences.

The system 100 may include a display device 110. The display device 110 may include any device that is capable or may facilitate in the displaying of one or more video frames (e.g., video frame 102b), including but not limited to a television, set top box, computer monitor, smartphone, tablet, projector, digital signage display, gaming console display, wearable device (e.g., smart glasses), virtual reality headset, smart home assistant with a screen, portable DVD player, public transportation screen, kiosks with touch display, airplane entertainment screen, medical equipment display, e-reader, car infotainment system, stadium jumbotron screen, handheld gaming device, or other suitable device.

At block 103, the MLM 106 may determine one or more unoccupied display areas of video frame 102a. An unoccupied display area may be defined by a bounded area of the video frame 102a that is generally free of important text and/or other important viewing information (e.g., images, logos). The MLM 106 may use one or more machine learning models, such as those previously discussed, to identify important text and/or important images in video frame 102a. If important text and/or important images are identified, the MLM 106 may determine one or more occupied display areas of video frame 102a. An occupied display area may be defined by a bounded area of the video frame 102a that includes important text and/or other important viewing information (e.g., images, logos). For example, the MLM 106 may define the one or more occupied display areas by calculating a buffer zone based on a defined percentage of the area around the detected important text (e.g., a 15% margin or padding extending outward from the text's bounding box). Additionally or alternatively, the MLM 106 may identify and utilize predefined regions or structures in the frame, such as scoreboard boxes, banners, or other visually distinct elements, as boundaries for caption placement.

The remaining area of the video frame 102a not within the occupied display area (or a portion of the remaining area) may define the unoccupied display area. If important text and/or important images are not identified in video frame 102a, the MLM 106 may determine that the entire video frame 102a, or a portion of the video frame, defines the unoccupied display area. For example, if important text and/or images are not identified in video frame 102a, the MLM 106 may default to one or more pre-determined areas (e.g., a top center or bottom center portion of the video frame), or it may utilize the unoccupied display area from one or more previous video frame to prevent the unoccupied display area (and thus, caption positioning) from unnecessarily changing.

At block 105, the MLM 106 may determine a position of a caption in the unoccupied display area. The MLM 106 may utilize one or more techniques to determine a caption position within the display area. For example, the MLM 106 may randomly select a position within the unoccupied display area and may ensure the placement adheres to basic constraints such as safe margins and avoiding overlap with important elements. This may be useful for scenarios where precise positioning is less critical or when a variety of placements is desired for aesthetic purposes. The MLM 106 may utilize a hierarchical set of predefined positions, checking each position sequentially until an unoccupied display area is found. For example, the MLM 106 may check for availability in the top center of the video frame 102a; if unavailable, check the bottom center; if unavailable, check the top left; and so on. The MLM 106 may divide the unoccupied display area into smaller regions to evaluate factors like proximity to important elements (e.g., detected important text and/or images), distance from the screen edges, and/or alignment preferences (e.g., center, bottom-left, or bottom-center). The MLM 106 may then determine the optimal region(s) for caption positioning.

Further, the MLM 106 may utilize saliency detection and/or visual balance algorithms to identify areas that minimize visual clutter while maintaining symmetry and avoiding crowded regions. The MLM 106 may analyze the size of the caption text and adjust its placement to accommodate safe margins, to ensure the text fits comfortably within the unoccupied display area without overlapping nearby visual elements. If the video frame 102a contains dynamic motion (e.g., moving objects or panning shots), the MLM 106 may adapt caption positioning to remain consistent and unobtrusive as the scene changes. The MLM 106 may also utilize attention-based models to determine where viewers are likely to focus their gaze and position captions in less prominent areas to avoid distracting from the primary visual content.

Further, the MLM 106 may determine a position of a caption based on the coordinates of the video frame by identifying specific x and y positions within the spatial grid of the one or more video frames (e.g., video frame 102a). For example, the MLM 106 may analyze video frame 102a, calculate safe margins, and select precise coordinates that ensure captions are placed in unobstructed regions. These coordinates may be dynamically adjusted to account for factors such as resolution, aspect ratio, and the presence of important text or images, ensuring optimal readability and minimal disruption to the visual content.

It should be appreciated that one or more of these methods may incorporate individual user preferences for caption placement. Thus, for example, if a user prefers caption positioning in the top center of the video frame 102a, the MLM 106 may prioritize that caption placement over other available placements. Additionally, it should be appreciated that a variety of methods for determining caption positioning within the unoccupied display area may be utilized and may depend on various factors, such as the type of video being analyzed and/or user preferences.

At block 107, the caption module 108 may access audio data associated with the video frame 102a. As previously explained, the audio data may enable the computing system 104 to determine the caption text for the video frame 102a. The audio data may include the caption text itself, such as from pre-existing caption files (e.g., SRT, VTT, or SCC formats), which may be provided with a video file of the input video frame (e.g., video frame 102a). The audio data may also include waveform patterns and frequency spectrum information, which may be converted to caption text in real-time. Further, the audio data may also include other data which may be provided to the MLM 106 to facilitate caption positioning, including but not limited to amplitude levels (e.g., to adjust the prominence of captions in loud or visually complex scenes), spatial audio metadata (e.g., to place captions near the location of the speaker and enhance contextual clarity), frequency spectrum data (e.g., to avoid placing captions near areas associated with distracting high-frequency sound), and other suitable data.

At block 109, the caption module 108 may insert caption data into video frame 102a to generate a video frame 102b. As determined at block 105, the caption data may correspond to the caption position in the unoccupied display area and may include caption text based in part on the audio data. For example, the caption data may include metadata and instructions that determine the precise positioning and styling of captions to ensure readability while preserving the visibility of important text and images detected within occupied display areas, such as scoreboards, subtitles, logos, or faces. The caption data may specify parameters like font size, text alignment, screen coordinates, safe margins, and/or line spacing to optimize placement in unoccupied regions. Caption data may also account for dynamic motion tracking to adapt placement during scene changes, spatial audio metadata to synchronize captions with directional audio cues, temporal synchronization to match captions with audio timing, and adaptive scaling to ensure readability across varying resolutions and devices. Additionally, caption data may incorporate information from preceding and subsequent frames to maintain consistency and alignment, ensuring captions transition smoothly and do not dramatically shift placement across frames, even in dynamic or fast-changing video sequences.

At block 111, the computing system 104 may transmit video frame 102b to display device 110 to be rendered for display. As previously explained, the display device 110 may be device that is capable or may facilitate in the displaying of one or more video frames (e.g., a television, set top box, etc.). The video frame 102b may be transmitted using any suitable transmission methods, including but not limited to HDMI, DisplayPort, wireless protocols like Miracast or Wi-Fi Direct, internet-based streaming protocols such as DASH (Dynamic Adaptive Streaming over HTTP) or HLS (HTTP Live Streaming), mobile network connections, local network connections like Ethernet, and/or other suitable methods. The video frame 102b may be encoded into a compatible format (e.g., H.264, H.265) for efficient transmission and decoded by an internal processor or software of the display device 110. Once decoded, the display device 110 may render the video frame 110b with captions onto its screen.

FIG. 2A illustrates an example video frame 202a being processed for positioning closed captions, according to certain embodiments. The system 200 may be analogous to the system 100, and the video frame 202a may be analogous to the video frame 102a. As previously explained, the input video frame 202a may be analyzed by a MLM (e.g., the MLM 106 described with respect to FIG. 1) to identify important visual elements (e.g., text, images, logos, objects, or other visual elements) in the video frame 202a, determine an unoccupied display area 205 of the video frame 202a, and determine a position of a caption in the unoccupied display area 205. In To determine the unoccupied display area 205, the MLM may use one or more machine learning models, such as those previously discussed, to identify important text and/or important images in video frame 202a. For example, as shown, the video frame 202a contains important text and images, and thus, the MLM may determine occupied display areas 203a-d. In particular, occupied display area 203a-b may contain important text, such as phone numbers, websites, prices, and product names and descriptions. Occupied display area 203c may contain important text and images, including announcement text, a phone number, and the banner itself. Occupied display area 203d may contain an important image and text (i.e., a logo and “LIVE” text). It should be appreciated that FIG. 2A may contain other important and/or non-important information and is merely intended to be an example for purposes of the present disclosure.

The identified important text and/or important images (or lack thereof) in frame 202a may be utilized to determine one or more occupied display areas 203a-d and/or one or more unoccupied display areas 205. The one or more of the occupied display areas 203a-d may be defined by the predefined regions and/or structures within the frame, such as the borders shown in occupied display areas 203a-c. Because occupied display area 203d does not have a border, the MLM may define occupied display area 203d by calculating a buffer zone based on a defined percentage of the area around the detected important text (e.g., a 15% margin or padding extending outward from the text's bounding box), or another suitable method.

The remaining area of the video frame 202a not within the occupied display areas 202a-d (or a portion of the remaining area) may define the unoccupied display area 205. As previously explained, the unoccupied display area 205 may be the entire area of the video frame 202a, a portion of the video frame 202a, and/or a predetermined area of the video frame 202a, depending on whether important text and/or important images are identified in video frame 202a. Additionally, a calculated or pre-determined buffer zone (e.g., a 5% margin) may separate the one or more occupied display areas 202a-d from the unoccupied display area 205.

As previously explained, the unoccupied display area 205 may be further analyzed and divided into smaller regions to evaluate factors like proximity to important elements (e.g., detected important text and/or images), distance from the screen edges, and/or alignment preferences (e.g., center, bottom-left, or bottom-center). For example, as shown in FIG. 2A, the unoccupied display area 205 a may be divided into smaller regions to ensure the caption placement does not cover the primary content being displayed, and the MLM may determine that the optimal region(s) for caption positioning are the top-center portion of the unoccupied display area 205 and/or the right side portion of the unoccupied display area 205, where there is available space for caption positioning.

FIG. 2B illustrates an example system for positioning closed captions, according to certain embodiments. The system 200, computing system 204, machine learning module (MLM) 206, caption module 208, caption data 211a-b, audio data 209, and display device 212 may be analogous to those previously described in connection with FIG. 1. As shown, computing system 204 may receive multiple input video frames (e.g., video frames 102a-b) that are sequential in a video stream and process these frames in real-time to extract relevant information (e.g., occupied and unoccupied display areas, important text and/or important images), and determine caption positioning for each video frame to ensure captions are optimally and consistently positioned. For example, the video frames may be part of a movie or other content. The content may include images of a person's hand, holding an object. The video frames may also include text (e.g., in the background of the scene such as a billboard etc.) The system 200 may identify the images of the person's hand and/or object as more important (e.g., to the plot) than the text in the background. The system 200 may therefore place the captions over the text rather than the images of the person's hand.

One or more of the video frames 202a-b may be analogous to the input video frame 102a of FIG. 1; however, video frames 202a-b are sequential in a video stream, where video frame 202a is an earlier frame in the sequence and video frame 202b is a subsequent frame in the sequence. For example, video frame 202b may be configured to be displayed immediately after video frame 202a, or may be configured to be displayed at some later time after video frame 202a.

The MLM 206 may analyze video frame 202a to determine a first unoccupied display area, determine a first caption position of a first caption in the first unoccupied display area, access audio data 209 associated with video frame 202a, insert caption data 211a (e.g., caption text associated with video frame 202a) into the video frame 202a to generate video frame 202c. The MLM 206 may then analyze video frame 202b to determine a second unoccupied display area, determine a second caption position of a second caption in the second unoccupied display area, access audio data 209 associated with video frame 202b, insert caption data 211b (e.g., caption text associated with video frame 202b) into the video frame 202b to generate video frame 202d. In some embodiments, the audio data 209 may be encoded with the video frames 202a-b and accessed thereby. Additionally or alternatively, the audio data 209 may be accessed separately.

Depending on the identified important visual information (or lack thereof) in the video frame 202a and the video frame 202b, the captions in each frame may be positioned in the same general location on both video frames 202a-b. Thus, the first caption and the second caption may be inserted in a first position based on coordinates defined by the video frame 202a and the video frame 202b. For example, if the MLM 206 determines that the visual elements on video frames 202 a-b have not changed within a certain threshold (e.g., by less than 5%), the MLM 206 may determine that the first caption position and the second caption position may be generally the same for both video frames 202a-b. For instance, the MLM 206 may determine that that the unoccupied display area of video frame 202a is in a top left corner region of video frame 202a. The MLM 206 may then determine that that the unoccupied display area of video frame 202b is also in a top left corner region of video frame 202b, where the unoccupied display area of video frame 202a and video frame 202b have not changed within a certain threshold (e.g., a difference of less than 10%, less than 15%, less than 20%, etc.). The MLM 206 may then determine that the first caption and the second caption may be positioned within the same general areas of video frames 202a-b.

However, in some situations, the MLM 206 may determine that the second caption position is different from the first caption position. Because the video frames 202a-b may correspond to a consistent display size/resolution, the coordinate defined by the video frames 202a-b may also be identical. Thus, the first caption may be inserted in a first position based on coordinates defined by the video frame 202a and the second caption may be inserted in a second position based on coordinates defined by the video frame 202b, so the second caption may appear in a different location when rendered for display. This may occur when the MLM 206 determines that the visual elements on the video frames 202a-b have changed above a certain threshold (e.g., by more than 5%) to warrant a change in positioning of the captions. For example, MLM 206 may determine that the unoccupied display area of video frame 202a is in a top left corner region of video frame 202a. The MLM 206 may then determine that video frame 202b contains important visual elements in the top left corner region of video frame 202b, and that the unoccupied display area of video frame 202b is the bottom right corner region of video frame 202b. The MLM 206 may therefore determine that the second caption should be positioned in a different location (i.e., the bottom right corner region) as compared to the first caption (positioned in the top left corner region).

In some embodiments, the difference in position between the first caption and the second caption may be below a predetermined threshold. This may prevent the captions from changing rapidly and/or dramatically from frame-to-frame, hindering the ability to view the captions on the screen. The predetermined threshold may be based on a variety of factors, including the amount of positional change of the caption(s) and the amount of time that the caption(s) has been at a certain position. For example, the first caption may be positioned in a first position based on coordinates of the video frame 202a, defined by specific x and y positions, e.g., (x₁, y₁), within spatial grid of the video frame 202a. The MLM 206 may then determine that the second caption should be positioned in a different location relative to the first caption, in a position, e.g., (x₂, y₂), on the spatial grid of video frame 202b. The MLM 206 may limit the change in position of the second caption, for example, if the change in absolute positions from (x₁, y₁) to (x₂, y₂) is beyond a certain threshold (e.g., more than 15% change in absolute positions.) The change in position of the second caption may be limited to less than or equal to 2%, less than or equal to 5%, less than or equal to 10%, etc.

The MLM 206 may also limit the change in positioning of the second caption relative to the first caption at least partially based on the amount of time that one or more preceding captions (e.g., the first caption) have been at a certain position on one or more preceding video frames (e.g., video frame 102a). For example, if the first caption has been at a first position on a first video frame for a relatively short period of time (e.g., less than 1 second), the MLM 206 may limit the change in position of the second caption. This may prevent the second caption position from changing rapidly and/or dramatically relative to the first caption position and/or other preceding caption positions, hindering the ability to view the captions on the screen. However, if the first caption has been at a first position on a first video frame for a relatively longer period of time (e.g., more than 1 minute), the MLM 206 may allow for a greater change in position between the first caption and the second caption.

It should be appreciated that the video frames 202a-b (as well as other preceding and/or subsequent video frames) may be analyzed in real-time. Thus, in some embodiments, the video frame 202a may be associated with a first display time and the video frame 202b may be associated with a second display time, and the difference between the two display times may be between about 16 milliseconds to about 42 milliseconds. Further, in some embodiments, the video frame 202b may be configured to be displayed immediately after video frame 202a.

FIG. 2C illustrates a processed video frame 202c, according to certain embodiments. The video frame 202c may be analogous to video frame 102b of FIG. 1, or video frames 202c-d of FIG. 2B. The caption 214 may be based on the caption data 211a and/or the caption data 211b. As the processed video frame 202c is rendered for display, the system 200 may cause the caption 214 to be generated and positioned within the processed video frame 202c. As previously explained, the MLM 206 may determine a position of a caption 214 in the unoccupied display area 205 based on one or more identified important visual display elements (defining occupied display areas 203a-d), and/or the length of the caption 214 (e.g., a sentence length, number of characters, etc.) using one or more of the techniques or methods previously discussed. For example, as shown in FIG. 2C, the caption 214 was positioned within the top center region of the unoccupied display area 205. Positioning in the top center region of the unoccupied display area 205 may be preferable in video frame 202c, due to the available space for caption positioning in this region. However, it should be appreciated that the MLM 206 may have positioned the caption in any other area, including the right-side region of the unoccupied display area 205, where there is also space for caption positioning, or even over a portion of the content (e.g., the two people shown in FIG. 2C) if the MLM 206 determines such content to be non-important or not-critical based on the context of the video or purpose of the video frame 202c. Additionally, as previously explained, the positioning may be influenced based at least in part on user preferences. Thus, if a user prefers captions positioned in the top or bottom regions, the MLM 206 may position the caption 214 based at least in part on those preferences.

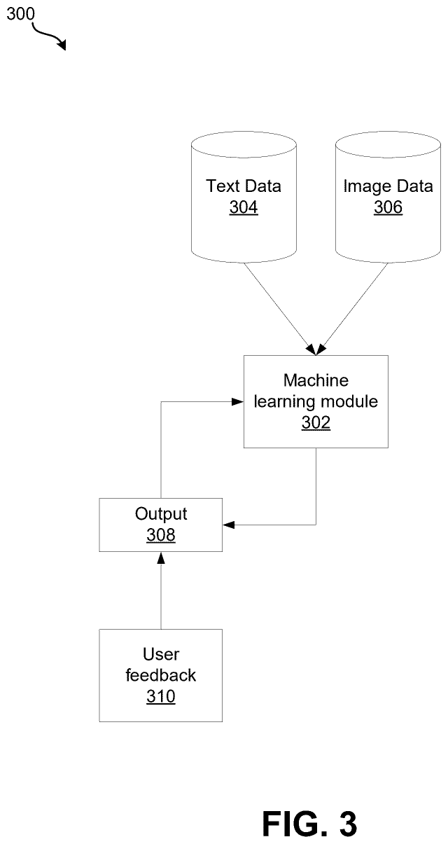

FIG. 3 illustrates a training process of a machine learning algorithm, according to certain embodiments. As shown, system 300 may have various datasets that may be used for training a machine learning module (MLM) 302, such as text data 304, image data 306, and/or other suitable data. Such data may come from video frames or other sources. The MLM 302 may include one or more machine learning algorithms and may be similar to the machine learning module discussed in connection with FIGS. 1 and 2B. In some embodiments, the MLM 302 may be implemented in an edge device. In other embodiments, the MLM 302 may be implemented on a remote computing device (e.g., a server, cloud-based computing system, etc.). The edge device and/or the remote computing device may be any suitable device, depending on the particular application, and may be one or more of the devices already discussed herein.

As previously discussed, the MLM 302 may include one or more machine learning models trained to identify important text in one or more input video frames (e.g., video frame 102a). Models used to identify important text in video frames may include but are not limited to an optical character recognition engine, a deep learning-based text detection model, a convolutional neural network-based object detection model, a transformer-based detection model, a computer vision library, a cloud-based vision analysis service, and/or a custom-trained machine learning framework. The identification of important text may enable the MLM 302 to determine portions of the input video frame with important text and portions of the input video frame without important text, thus aiding the MLM 302 in determining an unoccupied display area of the input video frame.

The MLM 302 may include one or more machine learning models trained to identify important images. Models used to identify important images in video frames may include but are not limited to convolutional neural networks, YOLO (You Only Look Once), SSD (Single Shot Multibox Detector), attention-based models, Vision Transformers (ViT), saliency detection models, and/or custom-trained machine learning frameworks. The identification of important images may enable the MLM 302 to determine portions of the input video frame with important images and portions of the input video frame without important images, thus aiding the MLM 302 in determining an unoccupied display area of the input video frame.

The text data 304 may include but is not limited to subtitles, captions, headlines, timestamps, phone numbers, scores on scoreboards, warnings, disclaimers, labels, product names, promotional text, titles, on-screen instructions, menu options, URLs, email addresses, hashtags, social media handles, watermarks, and/or embedded text within logos or graphics. The text data 304 may be used to train one or more machine learning models to identify and classify important text within video frames, determine bounding boxes or regions for the detected text, and/or distinguish between critical and non-critical text elements based on context, size, position, or relevance to the video content. In some embodiments, some or all of the text data 304 may include annotations labelling text within video frames. Furthermore, some or all of the text data 304 may include bounding boxes around the text of the video frames. The bounding boxes may be set a predetermined distance away from the horizontal and/or vertical edges of the text (e.g., 1 mm, 2 mm, etc., or 5 pixels away, 4 pixels away, etc.)

The image data 306 may include but is not limited to logos, faces, brand icons, product visuals, objects of interest, graphics, charts, maps, illustrations, diagrams, symbols, advertisements, visual overlays such as scoreboards, and/or infographics. The image data 306 may be used to train one or more machine learning models to detect and classify important images within video frames, identify bounding boxes or spatial regions for these images, and/or evaluate their relevance based on size, position, or contextual importance to the video content. In some embodiments, some or all of the image data 306 may include annotations labelling the important images within the video frames. Furthermore, some or all of the image data 306 may include bounding boxes around the important images of the video frames. The bounding boxes may be set a predetermined distance away from the horizontal and/or vertical edges of the important images (e.g., 1 mm, 2 mm, etc., or 5 pixels away, 4 pixels away, etc.)

The text data 304 and/or the image data 306 may be provided to the MLM 302, where one or more machine learning algorithms process and analyze the text data 304 and/or the image data 306 to yield an output 308. The output 308 may include any suitable output for the particular application, such as determining an unoccupied display area and/or a caption position, as previously described. The output 308 may be transmitted via an output signal to one or more display devices (shown in FIGS. 1-2C), and/or may be fed back into the MLM 302 for further processing and to improve its performance.

The output 308 may be evaluated for accuracy via user feedback 310. User feedback 310 may provide corrections or insights, for example, by ensuring the accuracy of the determined unoccupied display area and/or caption position and may include annotations to previously determined results (e.g., a “correct” determination, “false determination”, etc.). For instance, a user may provide feedback regarding the determined unoccupied display area and/or caption position, which may help the machine learning algorithms to determine the suitable unoccupied display area and/or caption position. Additionally, user feedback 310 may include individual preferences or personalized data, which may help train the machine learning algorithms to provide more personalized output 308. For example, a user may provide feedback on their preferred caption position, which may help the machine learning algorithms to determine the suitable determined unoccupied display area.

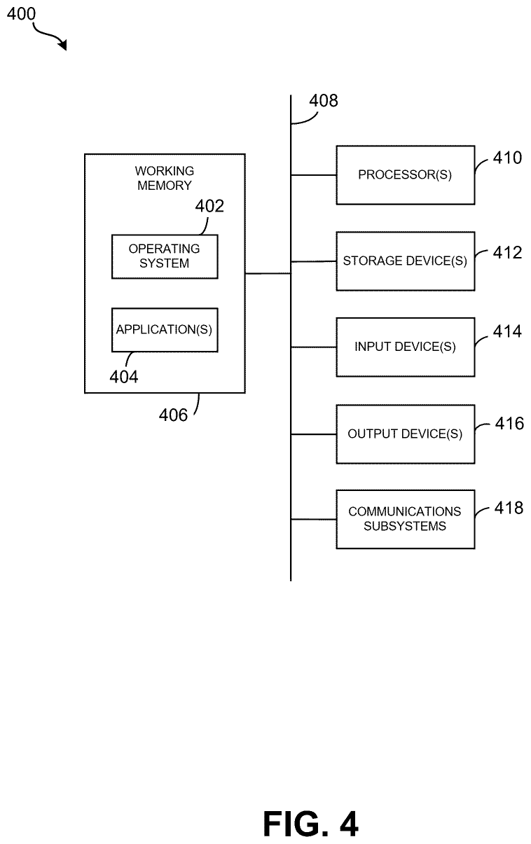

FIG. 4 illustrates an example computing system, according to certain embodiments. The computing system 400 is a simplified computing system that can be used to implement various embodiments described and illustrated herein and may be similar to those previously discussed. A computing system 400 as illustrated in FIG. 4 may be incorporated into devices, including any of the devices previously discussed. FIG. 4 provides a schematic illustration of one embodiment of a computing system 400 that can perform some or all of the steps of the methods and workflows provided by various embodiments. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computing system 400 is shown including hardware elements that can be electrically coupled via a bus 408, or may otherwise be in communication, as appropriate. The hardware elements may include one or more processors 410, including without limitation one or more general-purpose processors and/or one or more special-purpose processors such as digital signal processing chips, graphics acceleration processors, and/or the like; one or more input devices 414, which can include any of the devices previously discussed, such as a camera or media server; and one or more output devices 416, which can include any of the devices previously discussed, such as a television.

The computing system 400 may further include and/or be in communication with one or more non-transitory storage devices 412, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computing system 400 might also include a communications subsystem 418, which can include without limitation a modem, a network card (wireless or wired), an infrared communication device, a wireless communication device, and/or a chipset such as a Bluetooth™ device, a 802.11 device, a Wi-Fi device, a Wi-Max device, cellular communication facilities, etc., and/or the like. The communications subsystem 418 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 418. In other embodiments, a portable electronic device, e.g., the first electronic device, may be incorporated into the computer system 400, e.g., an electronic device as an input device 414. In some embodiments, the computing system 400 will further include a working memory 406, which can include a RAM or ROM device, as described above.

The computing system 400 also can include software elements, shown as being currently located within the working memory 406, including an operating system 402, device drivers, executable libraries, and/or other code, such as one or more application programs 404, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 4, might be implemented as code and/or instructions executable by a computer and/or a processor within a computer; in an aspect, then, such code and/or instructions can be used to configure and/or adapt a general-purpose computer or other device to perform one or more operations in accordance with the described methods.

A set of these instructions and/or code may be stored on a non-transitory computer-readable storage medium, such as the storage device(s) 412 described above. In some cases, the storage medium might be incorporated within a computer system, such as computer system 400. In other embodiments, the storage medium might be separate from a computer system, e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computing system 400 and/or might take the form of source and/or installable code, which, upon compilation and/or installation on the computing system 400, e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computing system 400 to perform methods in accordance with various embodiments of the technology. According to a set of embodiments, some or all of the operations of such methods are performed by the computing system 400 in response to processor 410 executing one or more sequences of one or more instructions, which might be incorporated into the operating system 402 and/or other code, such as an application program 404, contained in the working memory 406. Such instructions may be read into the working memory 406 from another computer-readable medium, such as one or more of the storage device(s) 412. Merely by way of example, execution of the sequences of instructions contained in the working memory 406 might cause the processor(s) 410 to perform one or more procedures of the methods described herein. Additionally, or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 400, various computer-readable media might be involved in providing instructions/code to processor(s) 410 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 412. Volatile media include, without limitation, dynamic memory, such as the working memory 406.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400.

The communications subsystem 418 and/or components thereof generally will receive signals, and the bus 408 then might carry the signals and/or the data, instructions, etc. carried by the signals to the working memory 406, from which the processor(s) 410 retrieves and executes the instructions. The instructions received by the working memory 406 may optionally be stored on a non-transitory storage device 412 either before or after execution by the processor(s) 410.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks. For example, executing instructions stored in the non-transitory computer-readable medium causes the processors to perform steps of methods and/or to implement features of components described herein.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

1. A system for positioning closed captions, comprising:
a machine learning module;
one or more processors; and
a non-transitory computer readable medium comprising instructions that, when executed by the one or more processors, cause the system to perform operations to:
determine, by the machine learning module, one or more unoccupied display areas of a first video frame;
access, by the machine learning module, first audio data associated with the first video frame;
determine, by the machine learning module, a first position of a first caption in the one or more unoccupied display areas, wherein the first position is based at least in part on the first audio data;
insert first caption data into the first video frame, the first caption data corresponding to the first caption in the unoccupied display area of the first video frame;
determine, by the machine learning module, one or more second unoccupied display areas of a second video frame;
access, by the machine learning module, second audio data associated with the second video frame;
determine, by the machine learning module, a second position of a second caption in the one or more second unoccupied display areas, wherein the second position is based at least in part on the second audio data;
insert second caption data into the second video frame, the second caption data corresponding to the second caption in the second unoccupied display area of the second video frame; and
transmit the first video frame and the second video frame to a display device to be rendered for display.

2. The system of claim 1, wherein:
the one or more unoccupied display areas are determined at least partially by detecting an absence of important text in at least a portion of the first video frame; and
the one or more second unoccupied display areas are determined at least partially by detecting an absence of important text in at least a portion of the second video frame.

3. The system of claim 1, wherein:
the first caption and the second caption are inserted in a first position based on coordinates defined by the first video frame and the second video frame.

4. The system of claim 1, wherein:
the first caption is inserted in a first position based on coordinates defined by the first video frame and the second caption is inserted in a second position based on coordinates defined by the second video frame, and wherein a difference between the first position and the second position is below a predetermined threshold.

5. The system of claim 4, wherein:
the predetermined threshold is based at least partially on time and the first position of the first caption.

6. The system of claim 1, wherein:
the first video frame is associated with a first display time and the second video frame is associated with a second display time, wherein a time difference between the first display time and the second display time is between about 16 milliseconds to about 42 milliseconds.

7. The system of claim 1, wherein a difference between the first position and the second position is less than or equal to 10%.

8. The system of claim 1, wherein:
the machine learning module is implemented by an edge device.

9. The system of claim 1, wherein:
the machine learning module is implemented on a remote computing device.

10. A method for positioning closed captions, comprising:
determining, by a machine learning module implemented on a computing system, one or more unoccupied display areas of a first video frame;
accessing, by the machine learning module, first audio data associated with the first video frame;
determining, by the machine learning module, a first position of a first caption in the one or more unoccupied display areas, wherein the first position is based at least in part on the first audio data;
inserting, by the computing system, first caption data into the first video frame, the first caption data corresponding to the first caption in the one or more unoccupied display area of the first video frame;
determining, by the machine learning module, one or more second unoccupied display areas of a second video frame;
accessing, by the machine learning module, second audio data associated with the second video frame;
determining, by the machine learning module, a second position of a second caption in the one or more second unoccupied display areas, wherein the second position is based at least in part on the second audio data;
inserting, by the computing system, second caption data into the second video frame, the second caption data corresponding to the second caption in the second unoccupied display area of the second video frame; and
transmitting, by the computing system, the first video frame and the second video frame to a display device to be rendered for display.

11. The method of claim 10, wherein:
the one or more unoccupied display areas are determined at least partially by detecting an absence of important text in at least a portion of the first video frame; and
the one or more second unoccupied display areas are determined at least partially by detecting an absence of important text in at least a portion of the first video frame.

12. The method of claim 10, wherein:
the first caption and the second caption are inserted in a first position based on coordinates defined by the first video frame and the second video frame.

13. The method of claim 10, wherein:
the first caption is inserted in a first position based on coordinates defined by the first video frame and the second caption is inserted in a second position based on coordinates defined by the second video frame, and wherein a difference between the first position and the second position is below a predetermined threshold.

14. The method of claim 13, wherein the predetermined threshold is based at least partially on time and the first position of the first caption.

15. The method of claim 10, wherein:
determining the one or more unoccupied display areas of the first video frame comprise:
determining a first occupied display area of the first video frame, wherein the first occupied display area is defined by a bounded area of the first video frame designated for displaying text, and at least a portion of a remaining area of the first video frame defines at least one unoccupied display area of the one or more unoccupied display areas; and
determining the one or more second unoccupied display areas of the second video frame comprise:
determining a second occupied display area of the second video frame, wherein the second occupied display area is defined by a bounded area of the second video frame designated for displaying text, and at least a portion of a remaining area of the second video frame defines at least one second unoccupied display area of the one or more second unoccupied display areas.

16. The method of claim 10, wherein:
the machine learning module comprise at least one of an optical character recognition engine, a deep learning-based text detection model, a convolutional neural network-based object detection model, a transformer-based detection model, a computer vision library, a cloud-based vision analysis service, or a custom-trained machine learning framework.

17. The method of claim 10, wherein:
the computing system comprises at least one of a set top box or a television.

18. A non-transitory computer-readable medium containing instructions that, when executed by one or more processors, cause the one or more processors to perform operations comprising:
determining, by a machine learning module implemented on a computing system, one or more unoccupied display areas of a first video frame;
accessing, by the machine learning module, first audio data associated with the first video frame;
determining, by the machine learning module, a first position of a first caption in the one or more unoccupied display areas, wherein the first position is based at least in part on the first audio data;
inserting, by the computing system, first caption data into the first video frame, the first caption data corresponding to the first caption in the one or more unoccupied display areas of the first video frame;
determining, by the machine learning module, one or more second unoccupied display areas of a second video frame;
accessing, by the machine learning module, second audio data associated with the second video frame;
determining, by the machine learning module, a second position of a second caption in the one or more second unoccupied display areas, wherein the second position is based at least in part on the second audio data;
inserting, by the computing system, second caption data into the second video frame, the second caption data corresponding to the second caption in the second unoccupied display area of the second video frame; and
transmitting, by the computing system, the first video frame and the second video frame to a display device to be rendered for display.

19. The non-transitory computer-readable medium containing instructions of claim 18, wherein:
the first caption and the second caption are inserted in a first position based on coordinates defined by the first video frame and the second video frame.

20. The non-transitory computer-readable medium containing instructions of claim 18, wherein:
the first caption is inserted in a first position based on coordinates defined by the first video frame and the second caption is inserted in a second position based on coordinates defined by the second video frame, and wherein a difference between the first position and the second position is below a predetermined threshold.
